(19) United States
(12) Patent Application Publication
(10) Pub. No.: US 2021/0136327 A1
(43) Pub. Date: May 6, 2021

(54) VIDEO SUMMARIZATION SYSTEMS AND METHODS

(71) Applicant: SENSORMATIC ELECTRONICS, LLC, Boca Raton, FL (US)

(72) Inventors: Martin RENKIS, Nashville, TN (US); Lipphei ADAM, Nolensville, TN (US); Zoltan ALBERT, Nashville, TN (US); Thibaut DE BOCK, Nashville, TN (US)

(21) Appl. No.: 17/147,227

(22) Filed: Jan. 12, 2021

Related U.S. Application Data
(63) Continuation of application No. 16/399,744, filed on Apr. 30, 2019.
(60) Provisional application No. 62/666,366, filed on May 3, 2018.

(51) Int. Cl. H04N 7/18; G06K 9/00; H04N 5/765; G11B 27/10; H04N 7/01

(52) U.S. Cl. CPC H04N 7/181; G06K 9/00751; G06K 9/00771; H04N 5/247; G11B 27/10; H04N 7/0125; H04N 5/765

(57) ABSTRACT

A video summarization device includes a user input device, a communications interface, a processing circuit, and a display device. The user input device receives a first request to view a plurality of video streams including an indication of a first time associated with the plurality of video streams. The processing circuit transmits, via the communications interface, a second request to retrieve a plurality of image frames based on the indication of the first time to at least one of a first database and a second database. The processing circuit receives, from the at least one of the first database and the second database, the plurality of image frames. The processing circuit provides, to the display device, a representation of a plurality of video stream objects corresponding to the plurality of image frames received from the at least one of a first database and a second database.

### CROSS REFERENCE TO RELATED APPLICATIONS

The present application is a continuation of U.S. patent application Ser. No. 16/399,744 entitled “Video Summarization Systems and Methods,” filed on Apr. 30, 2019, which claims priority to and benefits from U.S. Provisional Application No. 62/666,366 entitled “Video Summarization Systems and Methods,” filed on May 3, 2018, the content of which is incorporated by reference its entirety.

### TECHNICAL FIELD

The present disclosure relates generally to the field of security cameras. More particularly, the present disclosure relates to video summarization systems and methods.

### BACKGROUND

Security cameras can be used to capture and store image information, including video information. The image information can be played back at a later time. However, it can be difficult for a user to efficiently review image information to identify an image of interest. In addition, it may be difficult for security systems to efficiently manage large amounts of image data.

### SUMMARY

One implementation of the present disclosure is a video summarization device. The video summarization device includes a user input device, a communications interface, a processing circuit, and a display device. The user input device receives a first request to view a plurality of video streams including an indication of a first time associated with the plurality of video streams. The processing circuit transmits, via the communications interface, a second request to retrieve a plurality of image frames based on the indication of the first time to at least one of a first database and a second database. The processing circuit receives, from the at least one of the first database and the second database, the plurality of image frames. The processing circuit provides, to the display device, a representation of a plurality of video stream objects corresponding to the plurality of image frames received from the at least one of a first database and a second database.

Another implementation of the present disclosure is a method of presenting video summarization. The method includes receiving, via a user input device of a client device, a first request to view a plurality of video streams, the first request including an indication of a first time associated with the plurality of video streams; transmitting, by the processing circuit via a communications interface of the client device, a second request to retrieve a plurality of image frames based on the indication of the first time to at least one of a first database and a second database maintaining the plurality of image frames; receiving, from the at least one of the first database and the second database, the plurality of image frames; and providing, by the processing circuit to a display device of the client device, a representation of a plurality of video stream objects corresponding to the plurality of image frames received from the at least one of a first database and a second database.

Another implementation of the present disclosure is a video recorder. The video recorder includes a communications interface and a processing circuit. The processing circuit receives at least one image frame from each of a plurality of image capture devices, the at least one image frame associated with an indication of time; determines to store the image frame in a local image database of the video recorder using a data storage policy; responsive to determining to store the image frame in the local image database, stores the image frame in the local image database; and transmits, using the communications interface, each image frame to a remote image database.

### BRIEF DESCRIPTION OF THE DRAWINGS

FIG. 1 is an example of a block diagram of a video summarization system according to an aspect of the present disclosure.

FIG. 2 is an example of a schematic diagram of a user interface of a video summarization system according to an aspect of the present disclosure.

FIG. 3 is an example of a flow diagram of a method of presenting video summarization according to an aspect of the present disclosure.

FIG. 4 is an example of a flow diagram of a method of video summarization according to an aspect of the present disclosure.

FIG. 5 is an example of a diagram for summarizing a video according to an aspect of the present disclosure.

FIG. 6 is an example of a flow diagram of a method of summarizing one or more videos according to an aspect of the present disclosure.

### DETAILED DESCRIPTION

Referring to the figures generally, video summarization systems and methods in accordance with the present disclosure can enable a user to review video data for a large number of cameras, where the video data is all synchronized to a same time stamp to more quickly identify frames of interest, and also to overlay the video data with various video analytics cues, such as motion detection-based cues. In existing systems, video data is typically presented based on user input indicating instructions to seek through the video data in a sequential manner, such as to seek through the video data until an instruction is received to stop play (e.g., when a user has identified a video frame of interest). For example, if a video surveillance system is deployed in a store that is robbed, a user may have to provide instructions to the video surveillance system to sequentially review video until the robbery events are displayed. Such usage can cause the video surveillance system to receive, from the user, instructions indicative of an approximate time of the specified event; otherwise, an entirety of video data may need to be sequentially reviewed until video of interest is displayed. It will be appreciated that such systems may be required to store large amounts of video data to ensure that a user can have available the entirety of the video data for review—even if the likelihood of the existing system receiving a request from a user to review the stored video data is relatively low due to the infrequency of robberies or other similar events. Similarly, existing systems may be unable to retrieve video data that is both synchronized and displayed simultaneously.

Video summarization systems and methods in accordance with the present disclosure can improve upon existing systems by retrieving stored video streams and simultaneously displaying synchronized video streams. In addition, and can also reduce data storage requirements for providing such functionality.

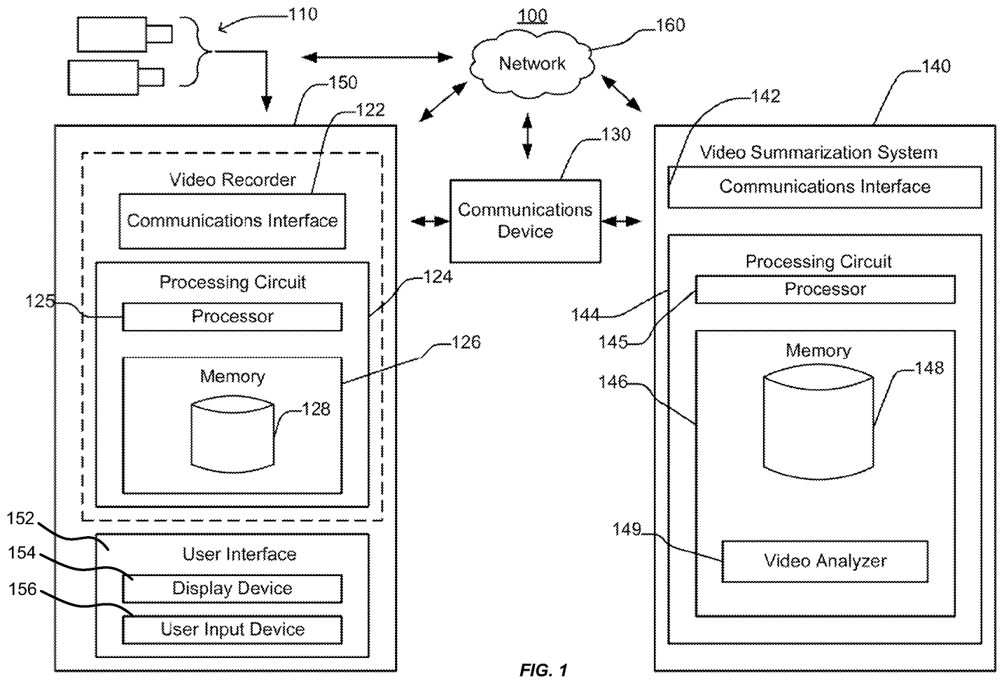

Referring now to FIG. 1, a video summarization environment 100 is shown according to an embodiment of the present disclosure. Briefly, the video summarization environment 100 includes a plurality of image capture devices 110, a video recorder 120, a communications device 130, a video summarization system 140, and one or more client devices 150.

Each image capture device 110 includes an image sensor, which can detect an image. The image capture device 110 can generate an output signal including one or more detected frames of the detected images, and transmit the output signal to a remote destination. For example, the image capture device 110 can transmit the output signal to the video recorder 120 using a wired or wireless communication protocol.

The output signal can be transmitted to include a plurality of images, which the image capture device 110 may arrange as an image stream (e.g., video stream). The image capture device 110 can generate the output signal (e.g., network packets thereof) to provide an image stream including a plurality of image frames arranged sequentially by time. Each image frame can include a plurality of pixels indicating brightness and color information. In some embodiments, the image capture device 110 assigns an indication of time (e.g., time stamp) to each image of the output signal. In some embodiments, the image sensor of the image capture device 110 captures an image based on time-based condition, such as a frame rate or shutter speed.

In some embodiments, the image sensor of the image capture device 110 detects an image responsive to a trigger condition. The trigger condition may be a command signal to capture an image (e.g., based on user input or received from video recorder 120).

The trigger condition may be associated with motion detection. For example, the image capture device 110 can include a proximity sensor, such that the image capture device 110 can cause the image sensor to detect an image responsive to the proximity sensor outputting an indication of motion. The proximity sensor can include sensor(s) including but not limited to infrared, microwave, ultrasonic, or tomographic sensors.

Each image capture device 110 can define a field of view, representative of a spatial region from which light is received and based on which the image capture device 110 generates each image. In some embodiments, the image capture device 110 has a fixed field of view. In some embodiments, the image capture device 110 can modify the field of view, such as by being configured to pan, tilt, and/or zoom.

The plurality of image capture devices 110 can be positioned in various locations, such as various locations in a building. In some embodiments, at least two image capture devices 110 have an at least partially overlapping field of view; for example, two image capture devices 110 may be spaced from one another and oriented to have a same point in their respective fields of view.

The video recorder 120 receives an image stream (e.g., video stream) from each respective image capture device 110, such as by using a communications interface 122. In some embodiments, the video recorder 120 is a local device located in proximity to the plurality of image capture devices 110, such as in a same building as the plurality of image capture devices 110.

The video recorder 120 can use the communications device 130 to selectively transmit image data based on the received image streams to the video summarization system 140, e.g., via network 160. The communications device 130 can be a gateway device. The communications interface 122 (and/or the communications device 130 and/or the communications interface 142 of video summarization system 140) can include wired or wireless interfaces (e.g., jacks, antennas, transmitters, receivers, transceivers, wire terminals, etc.) for conducting data communications with various systems, devices, or networks. For example, the communications interface 122 may include an Ethernet card and/or port for sending and receiving data via an Ethernet-based communications network (e.g., network 160). In some embodiments, communications interface 112 includes a wireless transceiver (e.g., a WiFi transceiver, a Bluetooth transceiver, a NFC transceiver, ZigBee, etc.) for communicating via a wireless communications network (e.g., network 160). The communications interface 122 may be configured to communicate via network 160, which may be associated with local area networks (e.g., a building LAN, etc.) and/or wide area networks (e.g., the Internet, a cellular network, a radio communication network, etc.) and may use a variety of communications protocols (e.g., BACnet, TCP/IP, point-to-point, etc.).

The processing circuit 124 includes a processor 125 and memory 126. The processor 125 may be a general purpose or specific purpose processor, an application specific integrated circuit (ASIC), one or more field programmable gate arrays (FPGAs), a group of processing components, or other suitable processing components. The processor 125 may be configured to execute computer code or instructions stored in memory 126 (e.g., fuzzy logic, etc.) or received from other computer readable media (e.g., CDROM, network storage, a remote server, etc.) to perform one or more of the processes described herein. The memory 126 may include one or more data storage devices (e.g., memory units, memory devices, computer-readable storage media, etc.) configured to store data, computer code, executable instructions, or other forms of computer-readable information. The memory 126 may include random access memory (RAM), read-only memory (ROM), hard drive storage, temporary storage, non-volatile memory, flash memory, optical memory, or any other suitable memory for storing software objects and/or computer instructions. The memory 126 may include database components, object code components, script components, or any other type of information structure for supporting the various activities and information structures described in the present disclosure. The memory 126 may be communicably connected to the processor 125 via the processing circuit 124 and may include computer code for executing (e.g., by processor 125) one or more of the processes described herein. The memory 126 can include various modules (e.g., circuits, engines) for completing processes described herein.

The processing circuit 144 includes a processor 145 and memory 146, which may implement similar functions as the processing circuit 124. In some embodiments, a computational capacity of and/or data storage capacity of the processing circuit 144 is greater than that of the processing circuit 124.

The processing circuit 124 of the video recorder 120 can selectively store image frame(s) of the image streams from the plurality of image capture devices 110 in a local image database 128 of the memory 126 based on a storage policy. The processing circuit 124 can execute the storage policy to increase the efficiency of using the storage capacity of the memory 126, while still providing selected image frame(s) for presentation or other retrieval as quickly as possible by storing the selected image frame(s) in the local image database 128 (e.g., as compared to maintaining images frames in remote image database 148 and not in local image database 128). The storage policy may include a rule such as to store image frame(s) from an image stream based on a sample rate (e.g., store n images out of every consecutive m images; store j images every k seconds).

The storage policy may include a rule such as to adjust the sample rate based on a maximum storage capacity of memory 126 (e.g., a maximum amount of memory 126 allocated to storing image frame(s)), such as to decrease the sample rate as a difference between the used storage capacity and maximum storage capacity decreases and/or responsive to the difference decreasing below a threshold difference. The storage policy may include a rule to store a compressed version of each image frame in the local image database 128; the video summarization system 140 may maintain uncompressed (or less compressed) image frames in the remote image database 148.

In some embodiments, the storage policy includes a rule to store image frame(s) based on a status of the image frame(s). For example, the status may indicate the image frame(s) were captured based on detecting motion, such that the processing circuit 122 stores image frame(s) that were captured based on detecting motion.

In some embodiments, the processing circuit 122 defines the storage policy based on user input. For example, the client device 150 can receive a user input indicative of the sample rate, maximum amount of memory to allocate to storing image streams, or other parameters of the storage policy, and the processing circuit 122 can receive the storage input and define the storage input based on the user input.

The processing circuit 122 can assign, to each image frame stored in the local image database 128, an indication of a source of the image frame. The indication of a source may include an identifier of the image capture device 110 from which the image frame was received, as well as a location identifier (e.g., an identifier of the building). In some embodiments, the processing circuit 122 maintains a mapping in the local image database 128 of indications of source to buildings or other entities—as such, when image frames are requested for retrieval from the local image database 128, the processing circuit 122 can use the indication of source to identify a plurality of streams of image frames to output that are associated with one another, such as by being associated with a plurality of image capture devices 110 that are located in the same building.

As discussed above, the video summarization system 140 may maintain many or all image frame(s) received from the image capture devices 110 in the remote image database 148. The video summarization system 140 may maintain, in the remote image database 148, mappings of image frame(s) to other information, such as identifiers of image sources, or identifiers of buildings or other entities.

In some embodiments, the video summarization system 140 uses the processing circuit 144 to execute a video analyzer 149. The processing circuit 144 can execute the video analyzer 149 to execute feature recognition on each image frame. Responsive to executing the video analyzer 149 to identify a feature of interest, the processing circuit 144 can assign an indication of the feature of interest to the corresponding image frame. In some embodiments, the processing circuit 144 provides the indication of the feature of interest to the video recorder 120, so that when providing image frames to the client device 150, the video recorder 120 can also provide the indication of the feature of interest.

In some embodiments, the processing circuit 144 executes the video analyzer 149 to detect a presence of a person. For example, the video analyzer 149 can include a person detection algorithm that identifies objects in each image frame, compares the identified objects to a shape template corresponding to a shape of a person, and detects the person in the image frame responsive to the comparison indicating a match of the identified objects to the shape template that is greater than a match confidence threshold. In some embodiments, the shape detection algorithm of the video analyzer 149 includes a machine learning algorithm that has been trained to identify a presence of a person. Similarly, the video analyzer 149 can include a motion detector algorithm, which may identify objects in each image frame, and compare image frames (e.g., across time) to determine a change in a position of the identified objects, which may indicate a removed or deposited item.

In some embodiments, the video analyzer 149 includes a tripwire algorithm, which may map a virtual line to each image frame based on a predetermined position and/or orientation of the image capture device 110 from which the image frame was received. The processing circuit 144 can execute the tripwire algorithm of the video analyzer 149 to determine if an object identified in the image frames moves across the virtual line, which may be indicative of motion.

As shown in FIG. 1, the client device 150 implements the video recorder 120; for example, the client device 150 can include the processing circuit 122. It will be appreciated that the client device 150 may be remote from the video recorder 120, and communicatively coupled to the video recorder 120 to receive image frames and other data from the video recorder 120 (and/or the video summarization system 140); the client device 150 may thus include a processing circuit distinct from processing circuit 122 to implement the functionality described herein.

The client device 150 includes a user interface 152. The user interface 152 can include a display device 154 and a user input device 156. In some embodiments, the display device 154 and user input device 156 are each components of an integral device (e.g., touchpad, touchscreen, device implementing capacitive touch or other touch inputs). The user input device 156 may include one or more buttons, dials, sliders, keys, or other input devices configured to receive input from a user. The display device 154 may include one or more display devices (e.g., LEDs, LCD displays, etc.). The user interface 152 may also include output devices such as speakers, tactile feedback devices, or other output devices configured to provide information to a user. In some embodiments, the user input device 156 includes a microphone, and the processing circuit 122 includes a voice recognition engine configured to execute voice recognition on audio signals received via the microphone, such as for extracting commands from the audio signals.

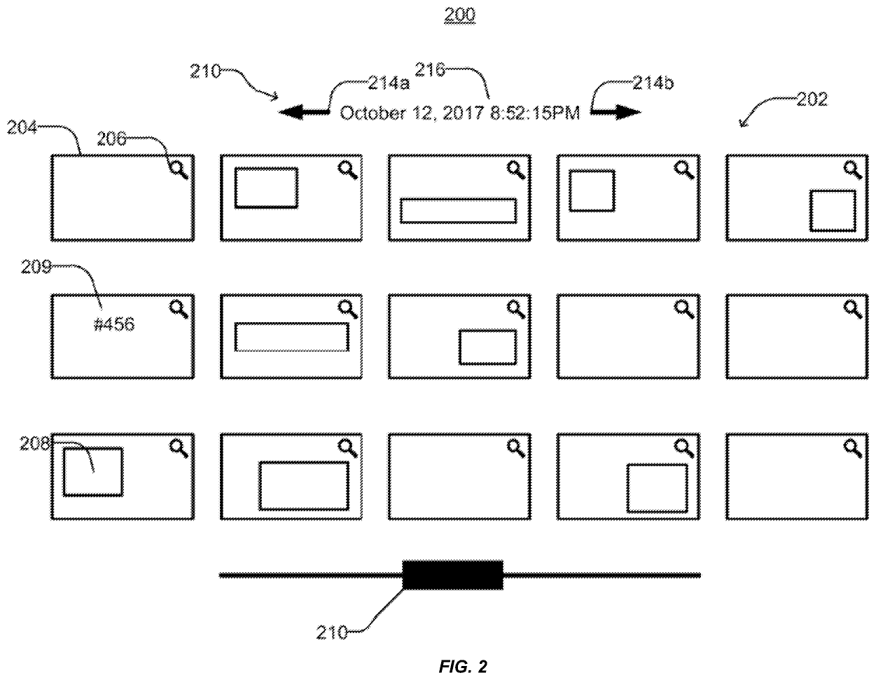

Referring further to FIG. 1 and to FIG. 2, the client device 150 can present a user interface 200 (e.g., via the display device 154). Briefly, the client device 150 can generate the user interface 200 to include a video playback object 202 including a plurality of video stream objects 204. Each video stream object 204 can correspond to an associate image capture device 110 of the plurality of image capture devices 110. Each video stream object 204 can include a detail view object 206. Each video stream object 204 can include at least one of a first analytics object 208 and a second analytics object 209. The video playback object 202 can include a first time control object 210, such as a scrubber bar. The video playback object 202 can include a second time control object 212, such as control buttons 214a, 214b, illustrated as arrows. The video playback object 202 can include a current time object 216.

The client device 150 can generate and present the user interface 200 based on information received from video recorder 120 and/or video summarization system 140. The client device 150 can generate a video request including an indication of a video time to request the corresponding image frames stored in the local image database 128 of the video recorder 120. In some embodiments, the video request includes an indication of an image source identifier, such as an identifier of one or more of the plurality of image capture devices 110, and/or an identifier of a location or building.

The video recorder 120 can use the request a key to retrieve the corresponding image frames (e.g., an image frame from each appropriate image capture device 110 at a time corresponding to the indication of the video time) and provide the corresponding image frames to the client device 150. It will be appreciated that because the video recorder 120 selectively stores image frames in the local image database 128, the local image database 128 may not include every image frame that the client device 150 may be expected to request; for example, the local image database 128 may store one out of every four image frames received from a particular image capture device 110. As such, the video recorder 120 may be configured to identify a closest in time image frame(s) based on the request from the client device 150 to provide to the client device 150. At the same time, the video recorder 120 may maintain a table of times for which image frame(s) are stored or not stored in the local image database 128, but rather in the remote image database 148. The video recorder 120 can use the table of times to request additional image frame(s) from the remote image database 148 that are within a threshold time of the indication of time of the video time of the request received from the client device 150 and/or provide the table of times to the client device 150 so that the client device 150 can directly request the additional image frame(s) from the remote image database 148. As such, the client device 150 can efficiently retrieve image frames of interest from the local image database 128, while also retrieving additional image frames from the remote image database 148 as desired.

The client device 150 generates the user interface 200 to present the plurality of video stream objects 204. The plurality of video stream objects 204 can provide a matrix of thumbnail video clips from each image capture device 110. The client device 150 can iteratively request image frames from the video recorder 120 and/or the video summarization system 140, so that video streams that were captured by the image capture devices 110 can be viewed over time. For example, the client device 150 can generate a plurality of requests for image frames, and update each frame of the user interface 200 to update each individual image frame of the user interface 200 as a function of time.

Each video stream object 204 is synchronized to a particular point in time, though the client device 150 may update each video stream object 204 individually or in batches depending on computational resources and/or network resources (because the client device 150 can generate the video stream objects 204 at a relatively fast frame rate, such as a frame rate faster than a human eye can be expected to perceive, the client device 150 can update the user interface 200 without causing perceptible lag, even across many video stream objects 204). As such, a user can quickly reviewed stored data from a large number of image capture devices 110 to identify frames of interest and also to follow motion from one camera to another.

As discussed above, the video recorder 120 may maintain image frames in the local image database 128 at a first level of compression (or other data storage protocol) that is greater than a second level of compression at which the video summarization system 140 maintains image frames in the remote image database 148. For example, the video summarization system 140 may maintain high definition image frames (e.g., having at least 480 vertical scan lines; having a resolution of at least 1920×1080), whereas the video recorder may maintain image frames at a lesser resolution. As such, the client device 150 can more efficiently use its computational resources (e.g., processing circuit 122) for presenting the plurality of video stream objects 204, as well as reduce the data size of communication traffic of image frames from the video recorder 120 to the client device 150. For example, the client device 150 can present the plurality of video stream objects 204 in a thumbnail resolution (e.g., less than high definition resolution).

In some embodiments, responsive to receiving a user input via the detail view object 206 of a particular video stream object 204, the client device 150 can modify the user interface 200 to present a single video stream object 204 corresponding to the particular video stream object 204. The client device 150 can generate a request to retrieve corresponding image frames from the remote image database 148 that are at the second level of compression (e.g., in high definition). As such, the client device 150 can provide high quality images for viewing by a user without continuously using significant computational and communication resources.

The client device 150 can generate the user interface 200 to present the at least one of the first analytics object 208 and the second analytics object 209 based on the indication of the feature of interest assigned to the corresponding image frame. When receiving the image frame (e.g., from the remote image database 148), the client device 150 can extract the indication of the feature of interest, and identify an appropriate display object to use to present the feature of interest. For example, the client device 150 can determine to highlight the appropriate video stream object 204, such as by surrounding the appropriate video stream object 204 with a red outline (e.g., first analytics object 208, which may mark an area in the video stream object 204 for motion or analytics). Second analytics object 209 may be a video analytics overlay.

In some embodiments, the client device 150 adjusts the image frames presented via the plurality of video stream objects 204 based on user input indicating a selected time. For example, the user input can be received via the first time control object 210. The user input may be a drag action applied to the first time control object 210. The client device 150 can map a position of the first time control object 210 to a plurality of times, and identify the selected time based on the position of the first time control object 210. In some embodiments, the client device 150 requests a plurality of images frames for each discrete position (and thus the corresponding time) of the first time control object 210, and updates the user interface 200 based on each request. This can create the perception that each of the video stream objects 204 is being rewound or fast-forwarded synchronously. Responsive to detecting the source of the user input indicating the selected time as being the first time control object 210, the client device 150 can generate the request for the image frames to be a relatively low bandwidth request, such as by directing the request to the local image database 128 and not the remote image database 148 and/or including a request for highly compressed image frames. As such, the client device 150 can efficiently request, receive, and present the user interface 200 while reducing or eliminating perceived lag.

The user input indicating the selected time may also be received via the second time control object 212 (e.g., via control buttons 214a, 214b). In some embodiments, because the user input received via the second time control object 212 may be indicative of instructions to focus on a particular point in time, rather than reviewing a large duration of time, the client device 150 can generate the request for the corresponding image frames to be a normal or relatively high bandwidth request.

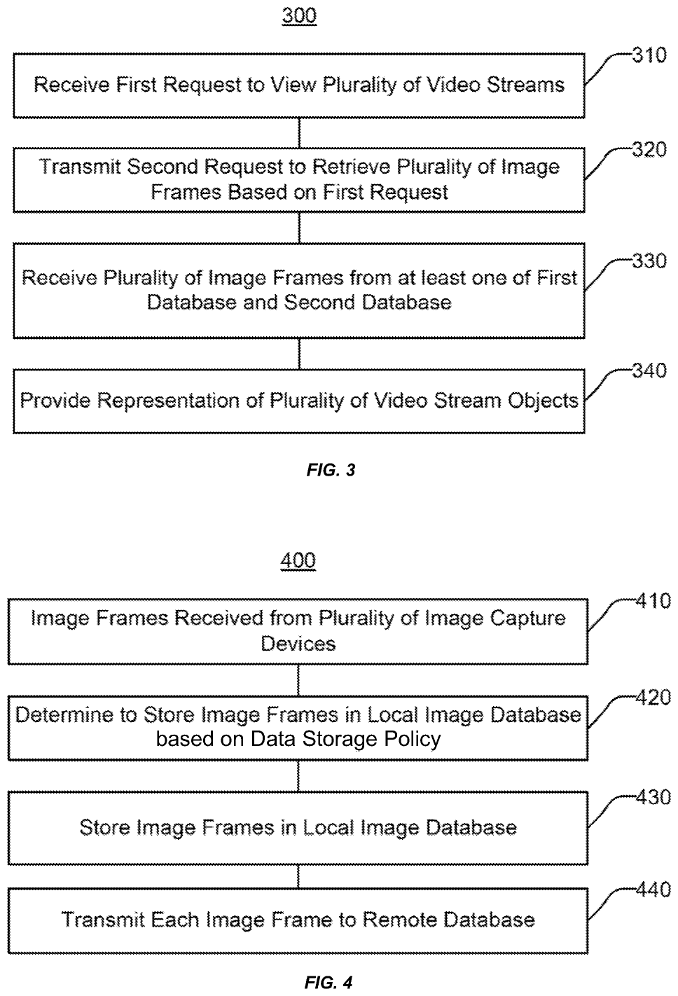

Referring now to FIG. 3, a method of presenting a video summarization is shown according to an embodiment of the present disclosure. The method can be implemented by various devices and systems described herein, including components of the video summarization environment 100 as described with respect to FIG. 1 and FIG. 2.

At 310, a first request to view a plurality of video streams is received. The first request is received via a user input device of a client device. The first request can include an indication of a first time associated with the plurality of video streams. The first request can include an indication of a source of the plurality of video streams, such as a location of a plurality of image capture devices that captured image frames corresponding to the plurality of video streams.

At 320, a second request is transmitted, by the processing circuit via a communications interface of the client device, to retrieve a plurality of image frames based on the first request (e.g., based on the indication of the first time). The second request can be transmitted to at least one of a first database and a second database maintaining the plurality of image frames. The first database can be a relatively smaller database (e.g., with relatively lesser storage capacity) as compared to the second database.

At 330, the plurality of image frames is received from the at least one of the first database and the second database. At 340, the processing circuit provides, to a display device of the client device, a representation of the plurality of video stream objects corresponding to the plurality of image frames received from the at least one of a first database and a second database.

In some embodiments, the user input device can receive additional requests associated with desired times at which image frames are to be viewed. For example, the user input device can receive a third request including an indication of a second time associated with the plurality of video streams. The processing circuit can update the representation of the plurality of video stream objects based on the third request. The third request may be received based on user input indicating the indication of the second time.

In some embodiments, the user input device can receive a request to view a single video stream object. Based on the request, the processing circuit can transmit a request to the second database for high definition versions of the image frames corresponding to the single video stream object. The processing circuit can use the high definition versions to update the representation to present the single video stream object (e.g., in high definition).

The processing circuit can identify a feature of interest assigned to at least one image frame of the plurality of video stream objects. The feature of interest may be an indication of motion detected, a person detected, an object deposited or removed, or a tripwire crossed in the image frame. The processing circuit can select a display object based on the identified feature of interest and use the display object to update the representation, such as to provide a red outline around the detected person.

Referring now to FIG. 4, a method of video summarization is shown according to an embodiment of the present disclosure. The method can be implemented by various devices and systems described herein, including components of the video summarization environment 100 as described with respect to FIG. 1 and FIG. 2.

At 410, an image frame is received from each of a plurality of image capture devices by a video recorder. The image frame can be received with an indication of time. The image frame can be received with an indication of a source of the image frame, such as an identifier of the corresponding image capture device.

At 420, the video recorder determines to store the image frame in a local image database using a data storage policy. In some embodiments, the data storage policy includes a sample rate at which the video recorder samples image frames received from the plurality of image capture devices. In some embodiments, the video recorder adjusts the sample rate based on a storage capacity of the local image database. In some embodiments, the data storage policy includes a rule to store image frames based on a status of the image frames. At 430, the video recorder, responsive to determining to store the image frame, stores the image frame in the local image database.

At 440, the video recorder transmits each image frame to a remote image database. The remote image database may have a larger storage capacity than the local image database, and may be a cloud-based storage device. The video recorder may transmit each image frame to the remote image database via a communications gateway.

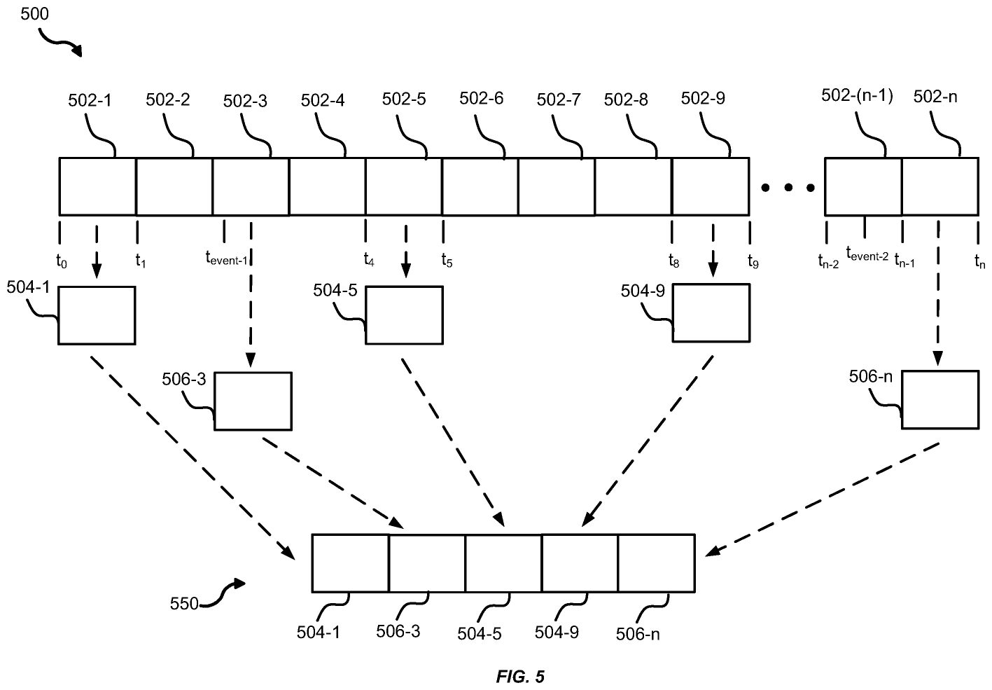

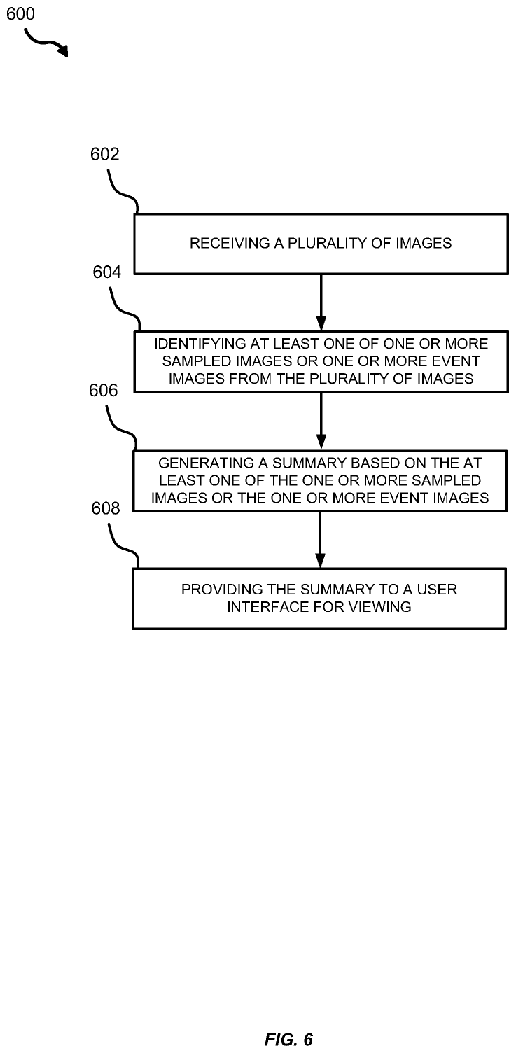

Referring now to FIG. 5, in some implementations, an example of a video summarization 500 may begin with a plurality of images 502 captured by one or more of the plurality of image capturing devices 110. The plurality of images 502 may be a portion of a surveillance video stream capturing a monitored site (not shown). The plurality of images 502 may include a first image 502-1, a second image 502-2, a third image 502-3, a fourth image 502-4, a fifth image 502-5, a sixth image 502-6, a seventh image 502-7, an eight image 502-8, a ninth image 502-9, . . . an n-1^{th} image 502-(n-1), and an n^{th} image 502-n. The plurality of images 502 may represent images captured at a fixed frame rate, such as 1 frame per second (fps), 2 fps, 5 fps, 10 fps, 20 fps, 30 fps, 50 fps, or 60 fps.

In some implementations, the video summarization system 140 may receive the plurality of images 502 via the communication interface 142. The video summarization system 140 may store the plurality of images 502 in the memory 146 and/or the remote image database 148. The video summarization system 140 may utilize the video analyzer 149 of the processing circuit 144 to summarize the plurality of images 502. In a non-limiting example, the video analyzer 149 may sample, at a fixed or random interval, the plurality of images 502 to generate sampled images 504-1, 504-5, and 504-9. The sampled image 504-1 may visually capture the monitored site between time t₀ to t₁. The sampled image 504-5 may visually capture the monitored site between time t₄ to t₅. The sampled image 504-9 may visually capture the monitored site between time t₈ to t₉. The windows (e.g., t₁-t₀, t₅-t₄, or t₉-t₈) of the sampled images 504-1, 504-5, and 504-8 may be the same or different. In some aspects, the windows of the sampled images 504-1, 504-5, and 504-8 may be represented by t_{window}. The sampled images 504-1, 504-5, and 504-9 may be spaced evenly (e.g., one sampled image per four frames or one sampled images per four t_{window}). In one aspect of the present disclosure, the video analyzer 149 may sample one image per minute (i.e., the sampled images 504-1 and 504-5 are one minute apart). In other aspects, the video analyzer 149 may sample one image per 1 second (s), 10 s, 20 s, 30 s, 2 minutes (min), 5 min, 10 min, or other intervals.

In some implementations, the sampled images 504-1, 504-5, and 504-9 may be duplicates of the images 502-1, 502-5, and 504-9, respectively. In other examples, the sampled images 504-1, 504-5, and 504-9 may be the compressed versions of the images 502-1, 502-5, and 504-9, respectively. For example, the video analyzer 149 may execute one or more lossy or lossless compression algorithms (e.g., run-length encoding, entropy encoding, chromatic subsampling, transform coding, etc.) on the images 502-1, 502-5, and 504-9 to generate the sampled images 504-1, 504-5, and 504-9.

In certain implementations, the video analyzer 149 may generate event images 506-3 and 506-n. The video analyzer 149 may generate the event images 506-3 and 506-n based on a first event occurring approximately at tₑᵥₑₙₜ₋₁ and a second event occurring approximately at tₑᵥₑₙₜ₋₂. For example, the video analyzer 149 may identify the first event by detecting a feature of interest occurring during the image 502-3. In response to detecting the feature of interest during the image 502-3, the video analyzer 149 may generate the event image 506-3 based on the image 502-3. The video analyzer 149 may identify the second event by detecting a feature of interest occurring during the image 502-(n-1). In response to detecting the feature of interest during the image 502-(n-1), the video analyzer 149 may generate the event image 506-n based on the image 502-(n-1). The feature of interest may be an indication of motion detected, a person detected, an object deposited or removed, or a tripwire crossed in the image frame.

In some aspects, after the detection of an event based on a first feature of interest, the video analyzer 149 may suspend generating event images based on a second feature of interest (same or different than the first feature of interest) for a predetermined amount of time. For example, after the video analyzer 149 generates the event image 506-3 based on the first event at tₑᵥₑₙₜ₋₁, the video analyzer 149 may suspend generating additional event images based on additional events occurring between tₑᵥₑₙₜ₋₁ and tₑᵥₑₙₜ₋₁+τ, where τ is the cool-down time. In some instances, the cool-down time may be 1 s, 2 s, 5 s, 15 s, 30 s, 1 min, 2 min, 5 min, or other times.

In certain examples, an event image may include an image at a predetermined time of the day. In other examples, an event image may be an image “flagged” by an operator (e.g., the operator explicitly selects an event image to be included in a video summary).

In certain implementations, the video analyzer 149 may search for events within a designated “surveillance zone” within an image.

Still referring to FIG. 5, the video analyzer 149 may generate a summary 550 including the sampled images 504-1, 504-5, and 504-9 and the event images 506-3 and 506-n. The summary 550 may allow an operator to quickly view selected images of the plurality of images 502. The summary 550 may include analytical data associated with at least one of the sampled images 504-1, 504-5, and 504-9 or the event images 506-3 and 506-n. Examples of analytical data may include a number of people in an image, a number of people entering an image, a number of people leaving an image, a number of people in a line, a license plate number of a vehicle, or other data. In some examples, the plurality of images 502 may be 1 gigabyte (GB), 2 GB, 5 GB, 10 GB, 20 GB, 50 GB, 100 GB or other amount of data. The summary 550 may be 100 kilobyte (kB), 200 kB, 500 kB, 1 megabyte (MB), 2 MB, 5 MB, 10 MB, 20 MB, 50 MB, or other amount of data. The summary 550 may be smaller than the plurality of images 502. The summary 550 may allow the video summarization system 140 to transmit snapshots of surveillance information to the one or more client devices 150 without utilizing a large amount of available bandwidth of the network 160.

Referring to FIG. 6, a method 600 of summarizing a video may be performed by the video summarization system 140.

At block 602, the method 600 may receive a plurality of images. For example, the video summarization system 140 may receive the plurality of images 502 via the communication interface 142.

At block 604, the method 600 may identify at least one of one or more sampled images or one or more event images. For example, the video analyzer 149 may identify at least one of the sampled images 504-1, 504-5, 504-9 or the event images 506-3, 506-n as described above.

At block 606, the method 600 may generate a summary based on the at least one of the one or more sampled images or the one or more event images. For example, the video analyzer 149 may generate the summary 550 based on the at least one of the sampled images 504-1, 504-5, 504-9 or the event images 506-3, 506-n as described above.

At block 608, the method 600 may provide the summary to a user interface for viewing. For example, the video summarization system 140 may provide the summary 550 to the one or more client devices 150 to be viewed on the user interface 152.

The various features associated with the examples described herein and shown in the accompanying drawings can be implemented in different examples and implementations without departing from the scope of the present disclosure. Therefore, although certain specific constructions and arrangements have been described and shown in the accompanying drawings, such embodiments are merely illustrative and not restrictive of the scope of the disclosure, since various other additions and modifications to, and deletions from, the described embodiments will be apparent to one of ordinary skill in the art. Thus, the scope of the disclosure is determined by the literal language, and legal equivalents, of the claims which follow.

What is claimed is:

1. A method of presenting images, comprising:
receiving a video stream including a plurality of stream image frames from at least one image capturing device;
identifying one or more sampled image frames to sample from the video stream;
generating a summary stream corresponding to the one or more sampled image frames;
providing the summary stream to an operator device;
receiving a request from the operator device corresponding to a selected image frame of the one or more sampled image frames;
obtaining a plurality of image frames from the plurality of stream image frames based on the request, wherein the plurality of image frames spans a time interval that includes a time associated with the selected image frame; and
providing the plurality of image frames for viewing.

2. The method of claim 1, further comprising:
detecting at least one feature of interest in at least one of the plurality of stream image frames;
generating one or more event image frames based on the at least one of the plurality of stream image frames; and
including the one or more event image frames in the summary stream.

3. The method of claim 2, wherein the at least one feature of interest includes one or more of an indication of motion detected, a person detected, an object deposited or removed, or a tripwire crossed in the one or more event image frames.

4. The method of claim 1, wherein the one or more sampled image frames are a subset of the plurality of stream image frames of the video stream, wherein the one or more sampled image frames are temporally separated by a periodic interval.

5. The method of claim 1, further comprising compressing the summary stream prior to providing the summary stream to the operator device.

6. The method of claim 1, further comprising generating analytical data associated with the summary stream, wherein providing the summary stream further comprises providing the analytical data to the operator device.

7. The method of claim 1, wherein image frames of the summary stream have a first video quality and the plurality of image frames have a second video quality higher than the first video quality.

8. The method of claim 7, wherein the image frames of the summary stream are thumbnail images and the plurality of image frames are high-definition image frames.

9. A non-transitory computer readable medium having instructions stored therein that, when executed by a processor, cause the processor to:
receive a video stream including a plurality of stream image frames from at least one image capturing device;
identify one or more sampled image frames to sample from the video stream;
generate a summary stream corresponding to the one or more sampled images;
provide the summary stream to an operator device;
receive a request from the operator device corresponding to a selected image frame of the one or more sampled image frames;
obtaining a plurality of image frames from the plurality of stream image frames based on the request, wherein the plurality of image frames spans a time interval that includes a time associated with the selected image frame; and
provide the plurality of image frames for viewing.

10. The non-transitory computer readable medium of claim 9, further comprising instructions that, when executed by the processor, cause the processor to:
detect at least one feature of interest in at least one of the plurality of stream image frames;
generate one or more event image frames based on the at least one of the plurality of stream image frames; and
include the one or more event image frames in the summary stream.

11. The non-transitory computer readable medium of claim 10, wherein the at least one feature of interest includes one or more of an indication of motion detected, a person detected, an object deposited or removed, or a tripwire crossed in the one or more event image frames.

12. The non-transitory computer readable medium of claim 9, wherein the one or more sampled image frames are a subset of the plurality of stream image frames of the video stream, wherein the one or more sampled image frames are temporally separated by a periodic interval.

13. The non-transitory computer readable medium of claim 9, further comprising instructions that, when executed by the processor, cause the processor to compress the summary stream prior to providing the summary stream to the operator device.

14. The non-transitory computer readable medium of claim 9, further comprising instructions that, when executed by the processor, cause the processor to generate analytical data associated with the summary stream, wherein instructions for providing the summary stream further comprises instructions for providing the analytical data to the operator device.

15. The non-transitory computer readable medium of claim 9, wherein image frames of the summary stream have a first video quality and the plurality of image frames have a second video quality higher than the first video quality.

16. The non-transitory computer readable medium of claim 15, wherein the image frames of the summary stream are thumbnail images and the plurality of image frames are high-definition image frames.

17. A method of presenting images, comprising:
receiving a video stream including a plurality of stream image frames from at least one image capturing device;
identifying one or more events in one or more of the plurality of stream image frames of the video stream;
generating a summary stream corresponding to one or more event image frames associated with the one or more of the plurality of stream image frames having the one or more events;
providing the summary stream to an operator device;
receiving a request from the operator device corresponding to a selected image frame of the one or more event image frames;
obtaining a plurality of image frames from the plurality of stream image frames based on the request, wherein the plurality of image frames spans a time interval that includes a time associated with the selected image frame; and
providing the plurality of image frames for viewing.

18. The method of claim 17, further comprising:
detecting at least one feature of interest in at least one of the plurality of stream image frames; and
including the at least one of the plurality of stream image frames in the one or more event image frames.

19. The method of claim 18, wherein the at least one feature of interest includes one or more of an indication of motion detected, a person detected, an object deposited or removed, or a tripwire crossed in the one or more event image frames.

20. The method of claim 17, further comprising:
identifying one or more sampled image frames based on the at least one of the plurality of stream image frames, wherein the one or more sampled image frames are a subset of the plurality of stream image frames of the video stream, wherein the one or more sampled image frames are temporally separated by a periodic interval; and
including the one or more sampled image frames in the summary stream.

21. The method of claim 17, further comprising compressing the summary stream prior to providing the summary stream to the operator device.

22. The method of claim 17, further comprising generating analytical data associated with the summary stream, wherein providing the summary stream further comprises providing the analytical data to the operator device.

23. The method of claim 17, wherein image frames of the summary stream have a first video quality and the plurality of image frames have a second video quality higher than the first video quality.

24. The method of claim 23, wherein the image frames of the summary stream are thumbnail images and the plurality of image frames are high-definition images.

25. A non-transitory computer readable medium having instructions stored therein that, when executed by a processor, cause the processor to:
receive a video stream including a plurality of stream image frames from at least one image capturing device;
identify one or more events in one or more of the plurality of stream image frames of the video stream;
generate a summary stream corresponding to one or more event image frames associated with the one or more of the plurality of stream image frames having the one or more events;
provide the summary stream to an operator device;
receive a request from the operator device corresponding to a selected image frame of the one or more event image frames;
obtain a plurality of image frames from the plurality of stream image frames based on the request, wherein the plurality of image frames spans a time interval that includes a time associated with the selected image frame; and
provide the plurality of image frames for viewing.

26. The non-transitory computer readable medium of claim 25, further comprising instructions that, when executed by the processor, cause the processor to:
detect at least one feature of interest in at least one of the plurality of stream image frames; and
include the at least one of the plurality of stream image frames in the one or more event image frames.

27. The non-transitory computer readable medium of claim 26, wherein the at least one feature of interest includes one or more of an indication of motion detected, a person detected, an object deposited or removed, or a tripwire crossed in the one or more event image frames.

28. The non-transitory computer readable medium of claim 25, further comprising instructions that, when executed by the processor, cause the processor to:
identify one or more sampled image frames based on the at least one of the plurality of stream image frames, wherein the one or more sampled image frames are a subset of the plurality of stream image frames of the video stream, wherein the one or more sampled image frames are temporally separated by a periodic interval; and
include the one or more sampled image frames in the summary stream.

29. The non-transitory computer readable medium of claim 25, wherein image frames of the summary stream have a first video quality and the plurality of image frames have a second video quality higher than the first video quality.

30. The non-transitory computer readable medium of claim 29, wherein the image frames of the summary stream are thumbnail images and the plurality of image frames are high-definition images.
